(19) United States
(12) Patent Application Publication
(10) Pub. No.: US 2024/0119313 A1
(43) Pub. Date: Apr. 11, 2024

(54) METHOD FOR KNOWLEDGE GRAPH EMBEDDING USING NUMERIC DATA AND HYPER-RELATIONAL INFORMATION AND SYSTEM THEREOF

(71) Applicants: SAMSUNG SDS CO., LTD., Seoul (KR); KOREA ADVANCED INSTITUTE OF SCIENCE AND TECHNOLOGY, Daejeon (KR)

(72) Inventors: Joyce Jiyoung WHANG, Daejeon (KR); Chanyoung CHUNG, Daejeon (KR); Jaejun LEE, Daejeon (KR)

(73) Assignees: SAMSUNG SDS CO., LTD., Seoul (KR); KOREA ADVANCED INSTITUTE OF SCIENCE AND TECHNOLOGY, Daejeon (KR)

(21) Appl. No.: 18/378,491

(22) Filed: Oct. 10, 2023

(30) Foreign Application Priority Data
Oct. 11, 2022 (KR) 10-2022-0129552
Nov. 28, 2022 (KR) 10-2022-0161191

(51) Int. Cl. G06N 5/022

(52) U.S. Cl. CPC G06N 5/022

(57) ABSTRACT

Provided is a method for embedding a knowledge graph. The method includes: obtaining a basic knowledge instance and a qualifier instance associated with the basic knowledge instance, wherein at least one of the basic knowledge instance or the qualifier instance comprises a mask element; generating, through an embedder, a first instance embedding corresponding to the basic knowledge instance and a second instance embedding corresponding to the qualifier instance; and performing a prediction of the mask element by inputting, to a predictor, an instance embedding associated with the mask element, wherein the instance embedding corresponds to the first instance embedding or the second instance embedding.

### CROSS-REFERENCE TO RELATED APPLICATION(S)

This application claims priority from Korean Patent Application No. 10-2022-0129552, filed on Oct. 11, 2022, and No. 10-2022-0161191, filed on Nov. 28, 2022, in the Korean Intellectual Property Office, and all the benefits accruing therefrom under 35 U.S.C. 119, the contents of which in its entirety are herein incorporated by reference.

### BACKGROUND

### 1. Technical Field

The disclosure relates to a method for embedding a knowledge graph including numeric data and a qualifier and a system for performing the method.

### 2. Description of the Related Art

A knowledge graph represents various entities existing in the real world and relations between the various entities in a graph structure. Knowledge graphs have been utilized in various fields, such as information retrieval, recommendation, and question answering.

A knowledge graph may include a plurality of knowledge triplets (i.e., knowledge composed of a head entity, a relation, and a tail entity). Recently, a complicated knowledge graph in which a qualifier is added has been proposed. Here, the qualifier (or additive/auxiliary knowledge) refers to knowledge added to amplify information of a knowledge triplet, and the qualifier and the knowledge triplet have been collectively referred to as hyper-relational knowledge.

Most methods for embedding a knowledge graph proposed so far are designed for general knowledge graphs, and thus, are difficult to apply to complicated knowledge graphs in which the qualifier is added. Furthermore, the methods for embedding a knowledge graph in which the qualifier is added proposed so far are designed for knowledge graphs having only discrete values, and thus, cannot be applied at all to knowledge graphs including numeric values.

### SUMMARY

Provided are a method capable of accurately embedding a knowledge graph including the hyper-relational knowledge and a system for performing the method.

Some embodiments of the disclosure provide an improved accuracy of embedding a knowledge graph including hyper-relational knowledge (the qualifier and the knowledge triplet).

Provided are a method capable of accurately embedding a knowledge graph including numeric data and a system for performing the method.

Provided are a method for augmenting a given knowledge graph using an incomplete knowledge instance in which a missing (mask) element exists, and a system for performing the method.

However, aspects of the disclosure are not restricted to those set forth herein. The above and other aspects of the disclosure will become more apparent to one of ordinary skill in the art to which the disclosure pertains by referencing the detailed description of the disclosure given below.

According to an aspect of the disclosure, a method for embedding a knowledge graph, the method being performed by at least one processor and including: obtaining a basic knowledge instance and a qualifier instance associated with the basic knowledge instance, wherein at least one of the basic knowledge instance or the qualifier instance comprises a mask element; generating, through an embedder, a first instance embedding corresponding to the basic knowledge instance and a second instance embedding corresponding to the qualifier instance; and performing a prediction of the mask element by inputting, to a predictor, an instance embedding associated with the mask element, wherein the instance embedding corresponds to the first instance embedding or the second instance embedding.

The method may further include updating the embedder and the predictor, based on a difference between a result of the prediction and a correct answer about the mask element.

The embedder may include a context encoder configured to: perform an analysis of an association between a first embedding of the basic knowledge instance and a second embedding of the qualifier instance, and generate the first instance embedding and the second embedding based on a result of the analysis of the association between the first embedding of the basic knowledge instance and the second embedding of the qualifier instance.

The context encoder may be implemented based on a self-attention module.

The generating of the first instance embedding and the second instance embedding may include: reflecting type information for distinguishing the basic knowledge instance and the qualifier instance from each other in the first embedding and the second embedding; and analyzing the association between the first embedding and the second embedding in which the type information is reflected through the context encoder.

The embedder may further include: a basic aggregator configured to aggregate first element embeddings of the basic knowledge instance to generate the first embedding; and an auxiliary aggregator configured to aggregate second element embeddings of the qualifier instance to generate the second embedding.

The qualifier instance may be a first qualifier instance. The generating of the first instance embedding and the second instance embedding may include: obtaining a second qualifier instance associated with the basic knowledge instance; perform, through the embedder, an analysis of an association among embeddings of the basic knowledge instance, the first qualifier instance, and the second qualifier instance; and generating the first instance embedding and the second instance embedding based on a result of the analysis of the association.

The predicting of the mask element may include inputting, to the predictor, element embeddings of a knowledge instance comprising the mask element.

The inputting of the element embeddings of the knowledge instance may include: reflecting information for distinguishing types of elements from each other in the element embeddings, and inputting, to the predictor, the element embeddings in which the information is reflected.

Type information of the knowledge instance corresponding to the instance embedding may be reflected in the instance embedding associated with the mask element, and wherein the instance embedding in which the type information is reflected is input to the predictor.

The predictor may include a context reflector and a prediction layer, and wherein the predicting of the mask element may include: generating a plurality of embeddings by reflecting, through the context reflector, the instance embedding associated with the mask element in the element embeddings; and predicting the mask element by inputting, to the prediction layer, an embedding corresponding to the mask element among the plurality of embeddings.

The context reflector may be implemented based on a self-attention module.

The mask element may be a discrete entity, and wherein the predictor comprises a classification layer outputting a predicted probability distribution for predefined entities.

The mask element may be a relation, and wherein the predictor comprises a classification layer outputting a predicted probability distribution for predefined relations.

The mask element may be a numeric entity, and wherein the predictor comprises a regression layer outputting a predicted numeric value.

The predictor may include a first predictor associated with a first prediction task and a second predictor associated with a second prediction task, and wherein, based on at least one of a type of the mask element, a format of a value of the mask element, and a type of a knowledge instance comprising the mask element, the first prediction task and the second prediction task are distinguished from each other.

The first predictor and the second predictor may be configured to share at least one weight parameter with each other.

The method may further include: generating a complete knowledge instance based on a result of the prediction in a knowledge instance comprising the mask element; and inserting the generated complete knowledge instance into the knowledge graph.

According to an aspect of the disclosure, a method for embedding a knowledge graph is provided, the method being performed by at least one computing device and including: obtaining a knowledge instance including a mask element, the mask element being a numeric entity; generating, through an embedder, an instance embedding of the knowledge instance; and predicting a value of the mask element by inputting, to a predictor comprising a regression layer, the instance embedding.

According to an aspect of the disclosure, a system for embedding a knowledge graph is provided, the system including: one or more processors; and a memory configured to store one or more instructions, wherein the one or more processors are configured to, by executing the stored one or more instructions, perform: obtaining a basic knowledge instance and a qualifier instance associated with the basic knowledge instance, wherein at least one of the basic knowledge instance or the qualifier instance comprises a mask element, generating, through an embedder, a first instance embedding corresponding to the basic knowledge instance and a second instance embedding corresponding to the qualifier instance, and predicting the mask element by inputting, to a predictor, an instance embedding associated with the mask element, wherein the instance embedding corresponds to the first instance embedding or the second instance embedding.

### BRIEF DESCRIPTION OF THE DRAWINGS

The above and other aspects and features of the disclosure will become more apparent by describing in detail example embodiments thereof with reference to the attached drawings, in which:

FIG. 1 is an illustrative diagram for schematically describing an operation of a system for embedding a knowledge graph according to some example embodiments of the disclosure;

FIGS. 2 and 3 illustrate knowledge graphs that may be referenced in various example embodiments of the disclosure;

FIG. 4 is an illustrative diagram for describing discrete entity prediction tasks according to some example embodiments of the disclosure;

FIG. 5 is an illustrative diagram for describing relation prediction tasks according to some example embodiments of the disclosure;

FIG. 6 is an illustrative diagram for describing numeric entity prediction tasks according to some example embodiments of the disclosure;

FIG. 7 is an illustrative flowchart illustrating a method for embedding a knowledge graph according to some example embodiments of the disclosure;

FIG. 8 is an illustrative diagram illustrating a training process of a deep learning model for embedding a knowledge graph according to some example embodiments of the disclosure;

FIG. 9 is an illustrative diagram illustrating a process of augmenting a knowledge graph using an incomplete knowledge instance according to some example embodiments of the disclosure;

FIGS. 10 and 11 are illustrative diagrams for describing a detailed structure of an embedder and a process of performing a discrete entity prediction task according to some example embodiments of the disclosure;

FIGS. 12 and 13 are illustrative diagrams for describing a detailed structure of a predictor and a process of performing a discrete entity prediction task according to some example embodiments of the disclosure;

FIG. 14 is an illustrative diagram for describing a process of performing a discrete entity prediction task according to some example embodiments of the disclosure;

FIGS. 15 and 16 are illustrative diagrams for describing a process of performing a relation prediction task according to some example embodiments of the disclosure;

FIGS. 17 and 18 are illustrative diagrams for describing a process of performing a numeric entity prediction task according to some example embodiments of the disclosure;

FIG. 19 is an illustrative diagram for describing a parameter sharing structure of a deep learning model according to some example embodiments of the disclosure; and

FIG. 20 is a diagram illustrating an illustrative computing device capable of implementing the system for embedding a knowledge graph according to some example embodiments of the disclosure.

### DETAILED DESCRIPTION

Hereinafter, example embodiments of the disclosure will be described with reference to the attached drawings. Advantages and features of the disclosure and methods of accomplishing the same may be understood more readily by reference to the following detailed description of example embodiments and the accompanied drawings. The disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the disclosure will only be defined by the appended claims and their equivalents.

In adding reference numerals to the components of each drawing, it should be noted that the same reference numerals are assigned to the same components as much as possible even when they are shown in different drawings.

Unless otherwise defined, all terms used in the present specification (including technical and scientific terms) may be used in a sense that may be commonly understood by those skilled in the art. In one embodiment, the terms defined in the commonly used dictionaries are not ideally or excessively interpreted unless they are specifically defined clearly. The terminology used herein is for the purpose of describing particular embodiments only and is not intended to be limit of the disclosure. In this specification, the singular also includes the plural unless specifically stated otherwise in the phrase, and the plural also includes the singular unless specifically stated otherwise in the phrase.

In one embodiment, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly or indirectly connected to or contacted with that other component. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. Similarly, the term “set” means one or more. Accordingly, the set of items may be a single item or a collection of two or more items.

Hereinafter, various example embodiments of the disclosure will be described in detail with reference to the accompanied drawings.

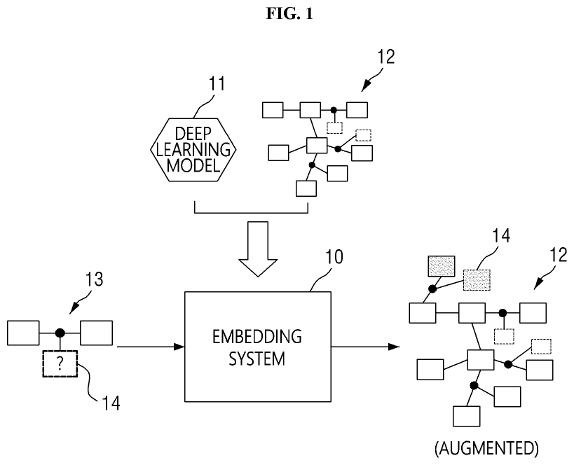

FIG. 1 is an illustrative diagram for describing an operation of a system 10 for embedding a knowledge graph according to some example embodiments of the disclosure. In FIG. 1, the system 10 for embedding a knowledge graph is illustrated as an ‘embedding system 10’. The system 10 for embedding a knowledge graph will also be abbreviated as an ‘embedding system 10’ in the following description.

As illustrated in FIG. 1, the embedding system 10 may be a system capable of embedding a knowledge graph 12 through a deep learning model 11. For example, the embedding system 10 may train the deep learning model 11 in a manner of performing a predefined prediction task using the knowledge graph 12, and enable the deep learning model 11 to have embedding capability for the knowledge graph 12 through the training.

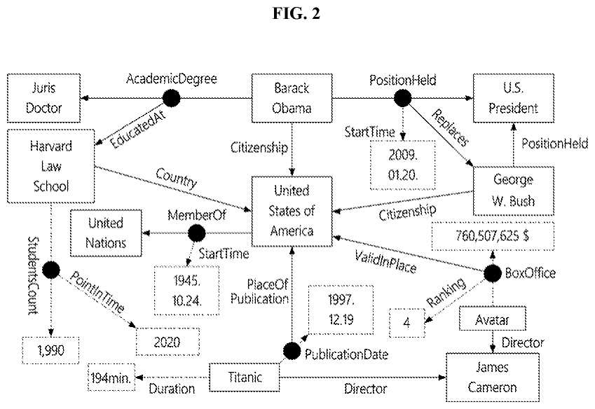

As illustrated in FIG. 2, the knowledge graph 12 handled by the embedding system 10 may be a complicated knowledge graph further including qualifier instances (e.g., {‘Educated At’, ‘Harvard Law School’}) in addition to basic knowledge instances (e.g., {‘Barack Obama’, ‘Academic Degree’, ‘Juris Doctor’}). In one embodiment, some of the knowledge instances (i.e., the basic knowledge instances and the qualifier instances) constituting the knowledge graph 12 may have numeric values (e.g., {‘Harvard Law School’, ‘Students Count’, ‘1,990’}). For reference, in FIG. 2 and the drawings after FIG. 2, entities and relations related to the numeric values are illustrated with dotted lines.

The knowledge instance refers to a unit of knowledge (e.g., a minimum unit) constituting the knowledge graph 12, and may be used interchangeably with terms such as ‘individual knowledge’, ‘knowledge entry’, ‘knowledge sample’, ‘knowledge record’, ‘knowledge tuple’, ‘knowledge triplet’, and ‘unit knowledge’ in some cases.

In one embodiment, the basic knowledge instance may refer to a general knowledge instance forming a structure of the knowledge graph 12. The basic knowledge instance may be represented (constructed) in the form of a triplet (e.g., {head entity, relation, tail entity} or {subject, predicate, object}) or 3-tuple, for example, but the scope of the disclosure is not limited thereto, and the form of the basic knowledge instance may be partially modified in some cases. However, hereinafter, a description will be provided on the assumption that the basic knowledge instance is represented (constructed) in the form of a triplet.

In one embodiment, the qualifier instance may refer to a knowledge instance added to amplify information of the basic knowledge instance. The qualifier may be used interchangeably with terms such as ‘auxiliary knowledge’ and ‘additive knowledge’ in some cases.

The qualifier instance may be represented (constructed) as a pair of a key and a value, for example, but the scope of the disclosure is not limited thereto, and the form of the qualifier instance may be changed in some cases. However, hereinafter, a description will be provided on the assumption that the qualifier instance is represented (constructed) as a pair of a key and a value and the key and the value correspond to a relation and an entity, respectively.

For reference, the basic knowledge instance and a qualifier instance associated with the basic knowledge instance may be referred to as a hyper-relational knowledge/information/fact instance. That is, one hyper-relational knowledge instance may be composed of one basic knowledge instance and one or more qualifier instances, and the number of qualifier instances may vary.

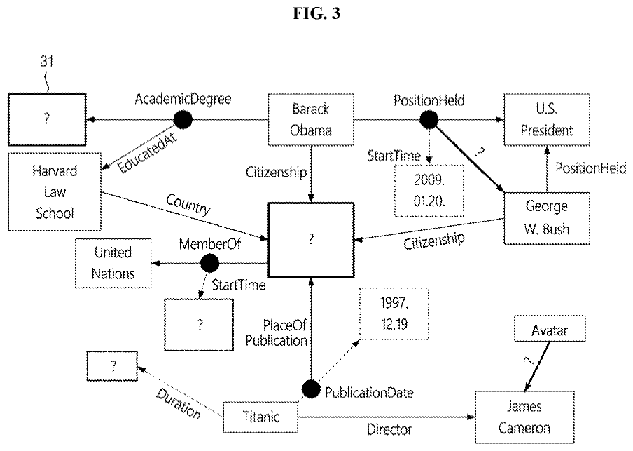

In order to accurately embed the knowledge graph 12 (e.g., FIG. 2), the embedding system 10 may perform various types of prediction tasks using the deep learning model 11. In other words, by performing the various types of prediction tasks using the deep learning model 11, the embedding system 10 has an improved accuracy of embedding the knowledge graph 12. Specifically, the embedding system 10 may perform embedding training (learning) for the deep learning model 11 in a manner of predicting mask elements or masked elements of knowledge instances constituting the knowledge graph 12. For example, as illustrated in FIG. 3, the embedding system 10 may perform embedding training in a manner of masking some elements of knowledge instances (see 31 in FIG. 3) and predicting the masked elements.

The types of prediction tasks may be variously defined according to the type (e.g., entity, relation) of the mask element, the format (e.g., discrete, numeric) of a mask element value, and the type (e.g., basic knowledge instance, qualifier instance) of the knowledge instance to which the mask element belongs, and various types of prediction tasks as follows may be used for training of the deep learning model 11.

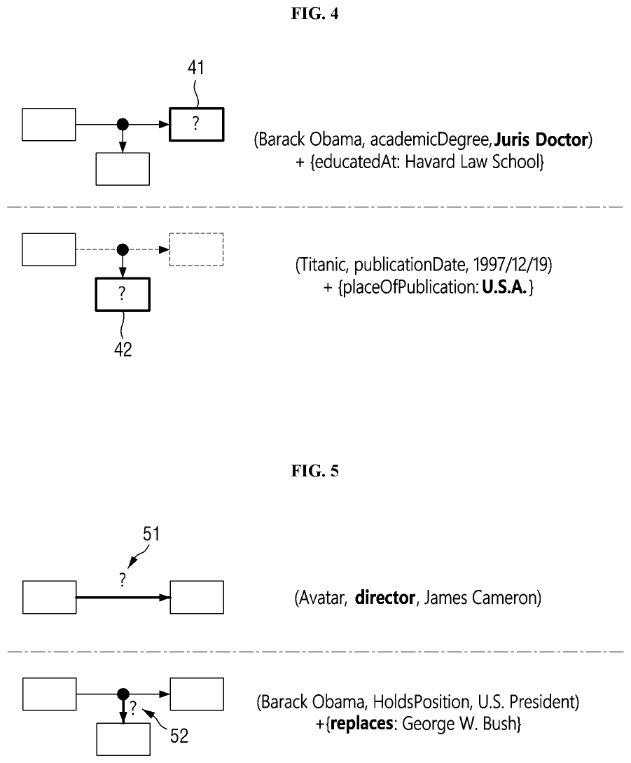

For example, as illustrated in FIG. 4, a task of predicting discrete (e.g., categorical) entities 41 and 42 (e.g., ‘Juris Doctor’, ‘U.S.A’) of the basic knowledge instance or the qualifier instance may be used to train the deep learning model 11 (i.e., mask elements 41 and 42 are discrete entities). On the right side of FIG. 4 and the like, examples of a knowledge instance and a qualifier instance associated with the prediction task are illustrated.

In one embodiment, for example, as illustrated in FIG. 5, a task of predicting relations 51 and 52 (e.g., ‘director’, ‘replaces’) of the basic knowledge instance or the qualifier instance may be used to train the deep learning model 11 (i.e., mask elements 51 and 52 are relations).

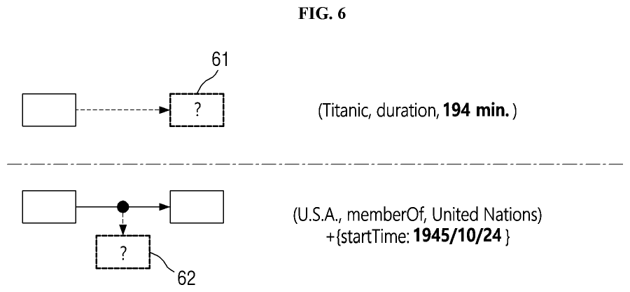

In one embodiment, for example, as illustrated in FIG. 6, a task of predicting numeric entities 61 and 62 (e.g., ‘194 min.’, ‘1945/10/24’) of the basic knowledge instance or the qualifier instance may be used to train the deep learning model 11 (i.e., mask elements 61 and 62 are numeric entities).

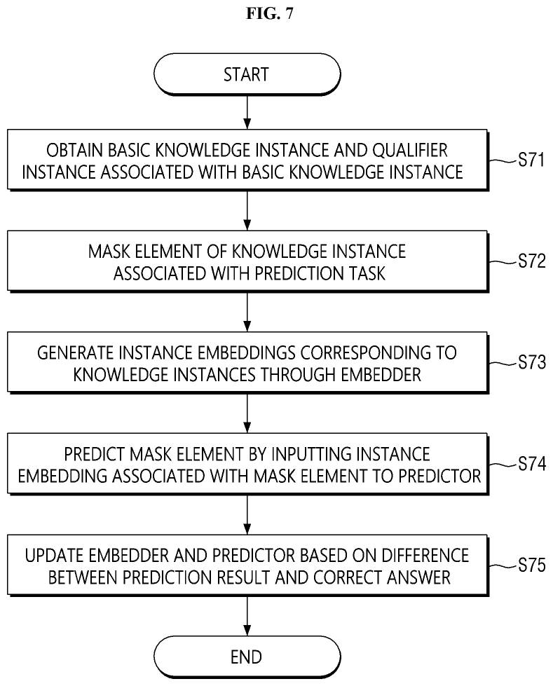

The embedding system 10 may build the deep learning model 11 that may accurately embed the complicated knowledge graph 12 by performing various prediction tasks illustrated, which will be described later with reference to FIG. 7 and the drawings after FIG. 7.

A description will be provided with reference to FIG. 1 again.

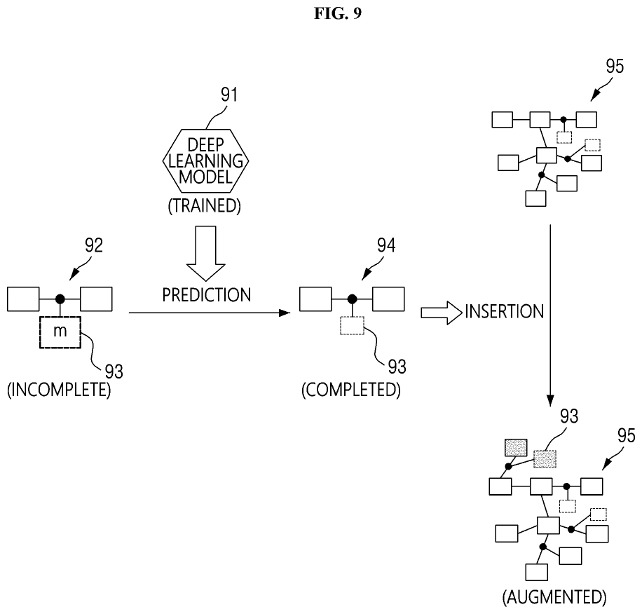

When the training of the deep learning model 11 is completed, the embedding system 10 may predict a missing (mask) element 14 (e.g., an entity or a relation) of an incomplete knowledge instance 13 through the trained deep learning model 11 and generate a complete (completed) knowledge instance by reflecting (or based on) the prediction result. In one embodiment, the embedding system 10 may augment the knowledge graph 12 by inserting the complete knowledge instance into the knowledge graph 12. A method for augmenting the knowledge graph 12 by the embedding system 10 will be further described later with reference to FIG. 9.

In some cases, the embedding system 10 may update the deep learning model 11 or build the deep learning model 11 again using the augmented knowledge graph 12.

The embedding system 10 may be implemented in at least one computing device. For example, all functions of the embedding system 10 may be implemented in one computing device or a first function of the embedding system 10 may be implemented in a first computing device and a second function of the embedding system 10 may be implemented in a second computing device. Alternatively, a function of the embedding system 10 may be implemented in a plurality of computing devices.

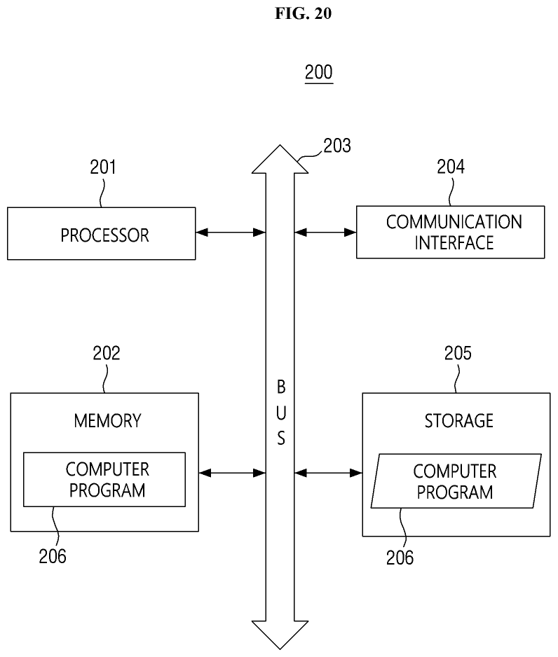

The computing device may include any device having a computing function, and reference is made to FIG. 20 for an example of such a device. The computing device is an aggregate in which various components (e.g., a memory, a processor, etc.) interact with each other, and may thus be referred to as a ‘computing system’ in some cases. In one embodiment, the computing system may refer to an aggregate in which a plurality of computing devices interact with each other.

Operations of the embedding system 10 according to some example embodiments of the disclosure have been schematically described with reference to FIGS. 1 to 6. Hereinafter, various methods (that is, detailed operations) that may be performed in the embedding system 10 described above will be described with reference to FIG. 7 and the drawings after FIG. 7.

Hereinafter, a description will be provided on the assumption that all operations of methods to be described later are performed in the embedding system 10 described above. Accordingly, when a subject of a specific operation is omitted, the specific operation is performed in the embedding system 10. However, some operations of methods to be described later may be performed in another computing device depending on the implementation manner.

In one embodiment, hereinafter, a description will be provided while changing reference numerals of the deep learning model 11 (see FIG. 1) and the knowledge graph 12 (see FIG. 1) according to example embodiments.

FIG. 7 is an illustrative flowchart illustrating a method for embedding a knowledge graph according to some example embodiments of the disclosure. However, this is only an example embodiment for achieving an object of the disclosure, and some operations may be added or deleted, if necessary.

As illustrated in FIG. 7, the method for embedding a knowledge graph according to example embodiments may start in operation S71 of obtaining a basic knowledge instance and a qualifier instance associated with the basic knowledge instance. For example, the embedding system 10 may select (obtain) a basic knowledge instance and a qualifier instance connected to the basic knowledge instance from a given knowledge graph (see FIG. 2). In other words, the embedding system 10 may select a hyper-relational knowledge instance from the given knowledge graph and obtain a basic knowledge instance and a qualifier instance from the hyper-relational knowledge instance. A manner of selecting the knowledge instances may be random selection, sequential selection, and others. The numbers of selected basic knowledge instances and qualifier instances may be one or two or more. In one embodiment, in some cases, only one of the basic knowledge instance and the qualifier instance may be selected.

In operation S72, an element of a knowledge instance (i.e., an element of a basic knowledge instance or a qualifier instance) associated with a prediction task may be masked. For example, when the prediction task is an entity prediction task (e.g., discrete entity prediction or numeric entity prediction), an entity (e.g., a head entity or a tail entity) of the obtained knowledge instance may be masked, and when the prediction task is a relation prediction task, a relation of the obtained knowledge instance may be masked.

In operation S73, instance embeddings corresponding to the basic knowledge instance and the qualifier instance may be generated through an embedder of the deep learning model.

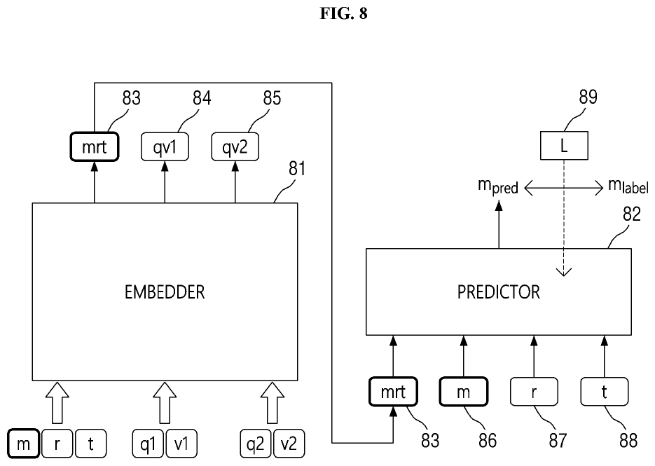

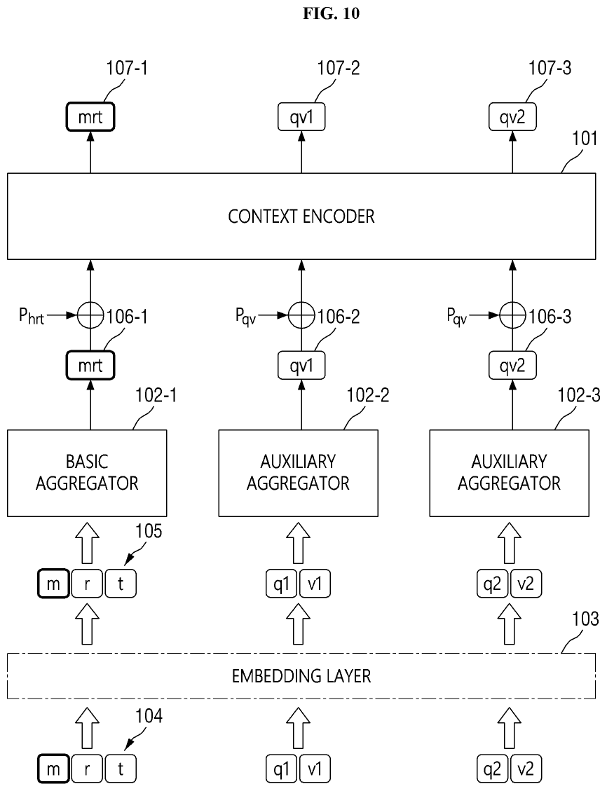

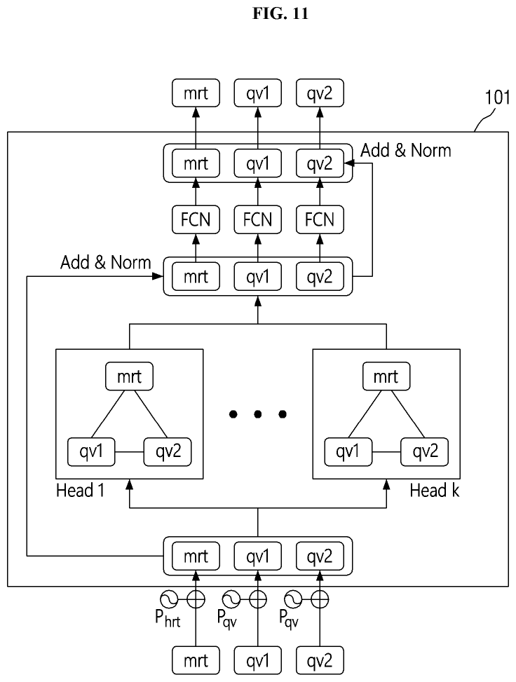

For example, as illustrated in FIG. 8, the deep learning model may be configured to include an embedder 81 outputting instance-based embeddings 83, 84, 85 and a predictor 82 predicting a mask element, and the embedding system 10 may generate instance embeddings 83, 84, 85 corresponding to the respective knowledge instances through the embedder 81. A detailed structure and an internal operation of the embedder 81 will be described in detail later with reference to FIGS. 10 and 11.

FIG. 8 illustrates a process in which the embedder 81 and the predictor 82 are trained through a discrete entity prediction task, and ‘m’ in FIG. 8 and the drawings after FIG. 8 refers to data associated with a mask element. In one embodiment, ‘h’, ‘r’, and ‘t’ refer to data associated with a head entity, a relation, and a tail entity, respectively, and ‘q’ and ‘v’ refer to data associated with a key and a value of a qualifier instance, respectively.

In one embodiment, an instance (or element) embedding refers to embedding data in units of knowledge instances (or elements), and since the embedding data is usually represented in the form of a vector, the instance (or element) embedding may be sometimes referred to as an ‘instance (or element) embedding vector’. In one embodiment, in the art, the embedding vector may be referred to as a term such as an ‘embedding representation’, an ‘embedding code’, a ‘latent vector’, a ‘latent code’, or a ‘latent representation’.

In operation S74, the mask element may be predicted by inputting the instance embedding associated with the mask element to the predictor of the deep learning model.

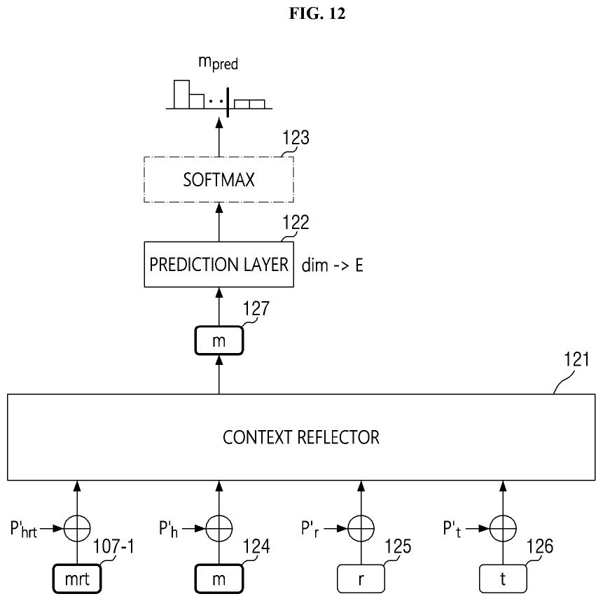

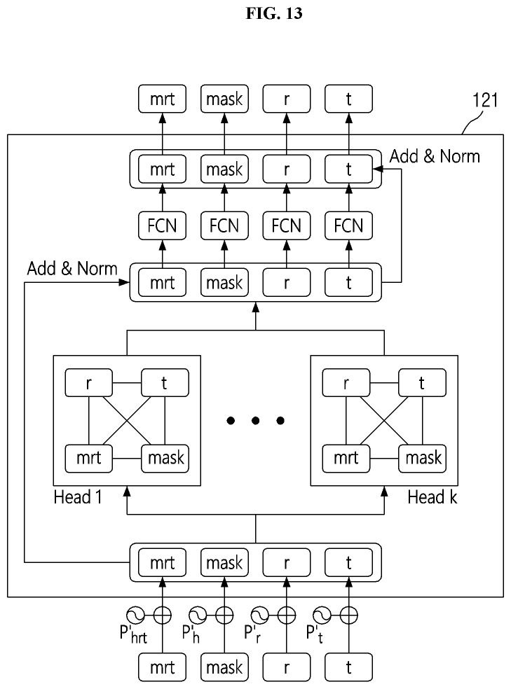

For example, as illustrated in FIG. 8, the embedding system 10 may input the instance embedding 83 (hereinafter referred to as a ‘mask instance embedding’) corresponding to a knowledge instance including the mask element (hereinafter referred to as a ‘mask instance’) and element embeddings 86, 87, 88 of the mask knowledge instance to the predictor 82. In this case, the predictor 82 may predict the value of the mask element based on the input embeddings 83, 86, 87, and 88. A detailed structure and an internal operation of the predictor 82 will be described in detail later with reference to FIGS. 12 and 13.

As another example, the embedding system 10 may predict the mask element by inputting only the mask instance embedding (e.g., 83) to the predictor (e.g., 82). As described later, since the mask instance embedding already includes information on the basic knowledge instance and the qualifier instance, the predictor (e.g., 82) may be configured to predict the mask element based only on the mask instance embedding (e.g., 83) in some cases.

As still another example, the embedding system 10 may predict the mask element by further inputting other instance embeddings (e.g., 84 and 85) in addition to the mask instance embedding (e.g., 83) to the predictor (e.g., 82).

As still another example, the embedding system 10 may predict the mask element based on various combinations of the examples described above.

In operation S75, the embedder and the predictor may be updated based on a difference (i.e., a loss) between a prediction result and the correct answer about the mask element. For example, as illustrated in FIG. 8, the embedding system 10 may calculate a loss 89 indicating a difference between a prediction result (see m_{pred}) and the correct answer (see m_{label}), and update weight parameters of the predictor 82 and the embedder 81 based on the calculated loss 89.

For reference, a manner of calculating the loss (e.g., 89) may be changed depending on the type of prediction task. As an example, when the type of prediction task is a numeric value prediction task (i.e., a regression task), the embedding system 10 may calculate the loss for the prediction result based on a loss function such as the mean square error loss. As an another example, when the type of prediction task is not the numeric value prediction task (i.e., is a classification task), the embedding system 10 may calculate the loss for the prediction result based on a loss function such as the cross-entropy loss. However, the scope of the disclosure is not limited thereto.

The above-described operations S71 to S75 may be repeatedly performed for other basic knowledge instances and qualifier instances constituting the knowledge graph. In one embodiment, the above-described operations S71 to S75 may be repeatedly performed while changing the type of prediction task. In this way, the deep learning model may accurately embed a complicated knowledge graph including qualifier instances and numeric values.

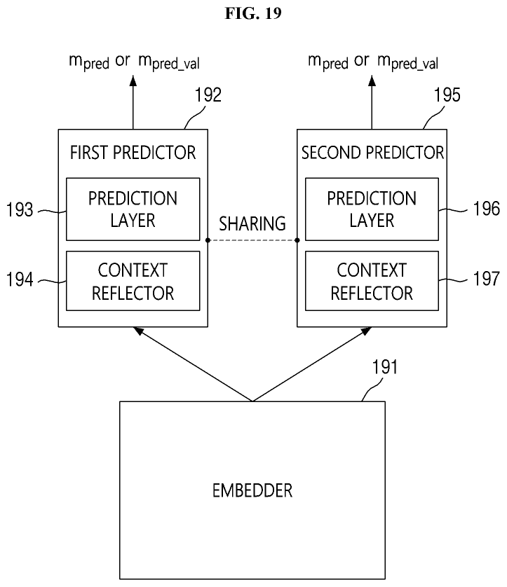

When a plurality of prediction tasks (see FIGS. 4 to 6) are used for embedding training, the embedding system 10 may calculate a loss for each prediction task and update the weight parameters of the predictor (e.g., 82) and the embedder (e.g., 81) based on the calculated losses. In this case, the predictor (e.g., 82) may exist independently for each task or a plurality of predictors may be configured in a form in which they share at least some weight parameters with each other, which will be further described with reference to FIG. 19. When the plurality of predictors share the weight parameters with each other, the embedding system 10 may update the weight parameters of the predictor (e.g., 82) and the embedder (e.g., 81) based on the total loss calculated through the sum of losses (e.g., weighted sum) for each prediction task.

When the training of the deep learning model is completed, the embedding system 10 may predict the missing (mask) element 14 of an incomplete knowledge instance 13 using the trained deep learning model and generate a complete knowledge instance by reflecting (or based on) the prediction result. Here, the incomplete knowledge instance may refer to a knowledge instance (e.g., a basic knowledge instance, a qualifier instance, or a combination thereof) with a missing (mask) element. In one embodiment, the embedding system 10 may augment a given knowledge graph by inserting the complete knowledge instance into the given knowledge graph.

For example, as illustrated in FIG. 9, the embedding system 10 may replace (set) a missing element 93 of an incomplete knowledge instance 92 with (to) a mask element, and predict the mask element 93 through a trained deep learning model 91. In one embodiment, the embedding system 10 may generate a complete knowledge instance 94 by reflecting (or based on) the prediction result and insert the complete knowledge instance 94 into a given knowledge graph 95. As a result, the knowledge graph 95 may be augmented.

The method for embedding a knowledge graph according to some example embodiments of the disclosure has been schematically described with reference to FIGS. 7 to 9. As described above, the deep learning model may be trained through tasks for predicting entities or relations constituting the qualifier instance. Accordingly, the deep learning model may perform embedding while accurately reflecting even the qualifier in the knowledge graph.

Hereinafter, a detailed structure of the deep learning model and a process of performing various types of prediction tasks will be described in more detail with reference to FIG. 10 and the drawings after FIG. 10.

First, a detailed structure of the deep learning model and a process of performing a discrete entity prediction task according to some example embodiments of the disclosure will be described with reference to FIGS. 10 to 14.

FIG. 10 illustrates a detailed structure of the embedder and an operation of the embedder associated with a discrete entity prediction task, according to some example embodiments of the disclosure. FIG. 10 illustrates a case of predicting a discrete entity of a basic knowledge instance, and it is assumed in FIG. 10 and the drawings after FIG. 10 that one basic knowledge instance and two qualifier instances are used in order to predict a mask element. However, the scope of the disclosure is not limited thereto, and the numbers of basic knowledge instances and qualifier instances may be changed.

As illustrated in FIG. 10, the embedder according to example embodiments may be configured to include a plurality of aggregators 102-1 to 102-3 and a context encoder 101. In some cases, the embedder may further include an embedding layer 103. Hereinafter, a description will be provided on the assumption that the embedder includes the embedding layer 103.

The embedding layer 103 may refer to a module that generates element embeddings (e.g., 105) for an input knowledge instance (e.g., 104). For example, the embedding layer 103 may receive values (e.g., a one-hot encoding, etc.) indicating elements of the basic knowledge instance 104, and generates embeddings 105 for each of the elements based on the received values. The embedding layer 103 may be implemented as a neural network layer such as a fully-connected layer (or a multi-layer perceptron), but the scope of the disclosure is not limited thereto.

Next, the aggregators 102-1 to 102-3 may refer to modules that aggregates the input element embeddings. Specifically, the basic aggregator 102-1 may aggregate element embeddings of a basic knowledge instance to generate an instance embedding 106-1 for the basic knowledge instance. Similarly, the auxiliary aggregators 102-2 (or 102-3) may aggregate element embeddings of a qualifier instance to generate an instance embedding 106-2 (or 106-3) for the qualifier knowledge instance. The auxiliary aggregators 102-2 and 102-3 may be implemented as one module or be implemented as modules independent of each other.

The aggregators may be implemented in various manners. For example, the aggregator may be implemented based on a module including trainable parameters, such as a fully-connected layer or be implemented based on a module that performs a predefined aggregation operation. Examples of the aggregation operation may include addition, product, concatenation, element-wise product, and the like, but the scope of the disclosure is not limited thereto.

Next, the context encoder 101 may refer to a module that comprehensively analyzes an association between the input instance embeddings 106-1 to 106-3 and reflects the analysis result to output (generate) instance embeddings 107-1 to 107-3 corresponding to the respective knowledge instances. Accordingly, the output instance embedding (e.g., 107-1) may also include information on other knowledge instances unlike the input instance embedding (e.g., 106-1), and in this respect, it may be understood that the corresponding module 101 is referred to as a ‘context encoder’. In some cases, the output instance embedding (e.g., 107-1) may be referred to as a ‘context embedding’.

The context encoder 101 may be implemented based on, for example, a self-attention module. For example, as illustrated in FIG. 11, the context encoder 101 may be implemented based on a transformer (e.g., the context encoder may be implemented by stacking N transformer blocks (here, N is a natural number greater than or equal to 1)). The transformer may perform operations such as association analysis, information exchange, and information collection between the information of the inputs through a self-attention module, a fully-connected layer/network, and the like, and a structure and an operation principle of the transformer has been already known well by one of ordinary skill in the art. FIG. 11 illustrates an internal structure of a transformer that performs operations such as multi-head attention, residual connection and layer normalization (see “Add & Norm”), and feed forward (see “FCN”).

A description will be provided with reference to FIG. 10 again.

When a discrete entity of a basic knowledge instance is predicted as illustrated in FIG. 10, the embedding system 10 may replace the discrete entity with a mask element (see m) and input the mask element to the embedder. In this case, associated qualifier instances may also be input to the embedder. In this case, the instance embedding 107-1 corresponding to the basic knowledge instance (i.e., the mask instance) and the instance embeddings 107-2 and 107-3 corresponding to the qualifier instances may be generated through the aggregators 102-1 to 102-3 and the context encoder 101. FIG. 10 has assumed the case of predicting the head entity of a basic knowledge instance, but the embedder may operate in the same manner as in FIG. 10 even in the case of predicting the tail entity of a basic knowledge instance.

In some example embodiments, as illustrated in FIG. 10, before the instance embeddings (e.g., 106-1) are input to the context encoder 101, type information (e.g., predefined encoding values) for distinguishing between the instance embeddings (e.g., 106-1) may be reflected in the respective instance embeddings 106-1 to 106-3. For example, type information of the basic knowledge instance (see Pₕᵣₜ) may be reflected in the instance embedding 106-1 for the basic knowledge instance, and type information of the qualifier instances (see P_{qv}) may be reflected in the instance embeddings 106-2 and 106-3 for the qualifier instances. However, the scope of the disclosure is not limited thereto. For example, when it is necessary to distinguish between the qualifier instances, information for distinguishing between the qualifier instances may be further reflected in the related instance embeddings (e.g., 106-2 and 106-3). A manner of reflecting the type information may be designed in various manners such as addition, product, concatenation, element-wise product. According to the present example embodiment, the context encoder 101 may distinguish and recognize different types of instance embeddings through the type information, and as a result, may more accurately analyze the association between the instance embeddings.

Hereinafter, a detailed structure of the predictor and an operation of the predictor associated with a discrete entity prediction task according to some example embodiments of the disclosure will be described with reference to FIGS. 12 and 13.

As illustrated in FIG. 12, the predictor according to example embodiments may include a context reflector 121 and a prediction layer 122. However, in some cases, the predictor may include only the prediction layer 122.

The context reflector 121 may refer to a module that comprehensively analyzes an association between a mask instance embedding 107-1 and element embeddings 124 to 126 of the mask instance and reflects the analysis result to output (generate) embeddings (e.g., 127) for final prediction. Accordingly, information of the mask instance embedding 107-1 may be reflected in the embedding 127 corresponding to the mask element, and in this respect, it may be understood that the corresponding module 121 is referred to as a ‘context reflector’.

The context reflector 121 may be implemented based on, for example, a self-attention module. For example, as illustrated in FIG. 13, the context reflector 121 may also be implemented based on a transformer (e.g., the context reflector 121 may be implemented by stacking K transformer blocks (here, K is a natural number greater than or equal to 1)). Similar to FIG. 11, FIG. 13 illustrates an internal structure of a transformer that performs operations such as multi-head attention, residual connection and layer normalization (see “Add & Norm”), and feed forward (see “FCN”).

A description will be provided with reference to FIG. 12 again.

The prediction layer 122 may refer to a module that predicts the mask element. When a discrete entity is predicted, the prediction layer 122 may be a classification layer that outputs a probability distribution for predefined entities (e.g., E entities). The prediction layer 122 may be implemented as a neural network layer such as a fully-connected layer (or a multi-layer perceptron), but the scope of the disclosure is not limited thereto.

When a discrete entity of the basic knowledge instance is predicted as illustrated in FIG. 12, the embedding system 10 may input the instance embedding 107-1 for the basic knowledge instance (i.e., the mask instance) and the element embeddings 124 to 126 to the context reflector 121.

In some example embodiments, as illustrated in FIG. 12, before the embeddings (e.g., 107-1) are input to the context reflector 121, type information (e.g., predefined encoding values) for distinguishing between the embeddings (e.g., 107-1) may be reflected in the respective embeddings 107-1 and 124 to 126. For example, type information of the basic knowledge instance (see P′ₕᵣₜ) may be reflected in the instance embedding 107-1 for the basic knowledge instance, and type information of elements (see P′ₕ, P′ᵣ, and P′ₜ) may be reflected in the element embeddings 124 to 126. For example, type information of a head entity (see P′ₕ) may be reflected in the embedding 124 for the head entity, and type information of a relation (see P′ᵣ) may be reflected in the embedding 125 for a relation. In this way, the context reflector 121 may distinguish and recognize different types of embeddings, and as a result, may more accurately analyze an association between the embeddings.

Next, the embedding system 10 may input the embedding 127 corresponding to the mask element among the embeddings output from the context reflector 121 to the prediction layer 122. In this case, a probability distribution for predefined entities (e.g., E entities) may be output through the prediction layer 122. FIG. 12 illustrates a case where the predicted probability distribution further passes through a softmax layer 123 and is then output.

When the predicted probability distribution is output, the embedding system 10 may update the weight parameters of the embedder and the predictor described above based on a difference (e.g., a cross-entropy value) between the predicted probability distribution and the correct answer about the probability distribution.

When the value of a missing (mask) element of an incomplete knowledge instance (e.g., a basic knowledge instance or a qualifier instance) is predicted, the embedding system 10 may determine the discrete value of the mask element based on the predicted probability distribution (e.g., an entity having the highest probability is predicted as the value of the mask element through an argmax function). In one embodiment, the embedding system 10 may generate a complete knowledge instance by reflecting (or based on) the determined value.

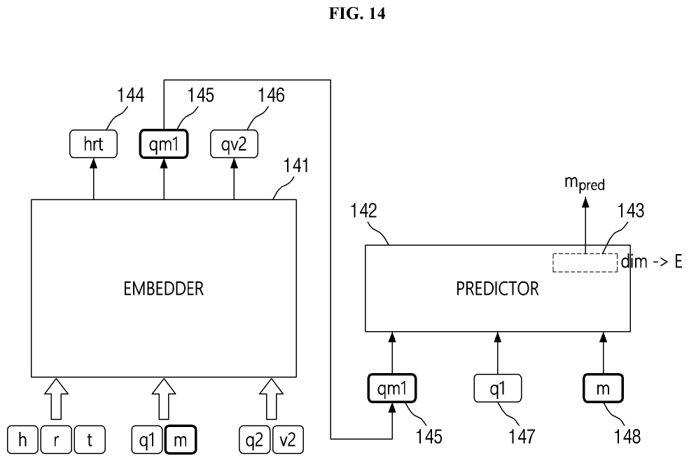

Hereinafter, a process of predicting a discrete entity of a qualifier instance will be described with reference to FIG. 14.

As illustrated in FIG. 14, the embedding system 10 may generate instance embeddings 144 to 146 for a basic knowledge instance and qualifier instances through an embedder 141. FIG. 14 illustrates a case of predicting a discrete entity of a first qualifier instance (i.e., a case where the mask instance is the first qualifier instance) as an example (see m).

Next, the embedding system 10 may input an instance embedding 145 corresponding to the qualifier instance (i.e., the mask instance) among the generated instance embeddings 144 to 146 to a predictor 142. In this case, element embeddings 147 and 148 of the corresponding knowledge instance may also be input to the predictor 142.

Next, the embedding system 10 may calculate a probability distribution for predefined entities (e.g., E entities) through a prediction layer 143. As described above, the prediction layer 143 may calculate the predicted probability distribution based on the embedding corresponding to the mask element.

In some example embodiments, before the embeddings 145, 147, and 148 are input to the predictor 142, type information for distinguishing between the embeddings 145, 147, and 148 may be reflected in the respective embeddings 145, 147, and 148. For example, type information of the qualifier instance may be reflected in the instance embedding 145 corresponding to the qualifier instance, and type information of corresponding elements (e.g., type information of a key element, type information of a value element, type information of a relation, type information of an entity, etc.) may be reflected in the element embeddings 147 and 148.

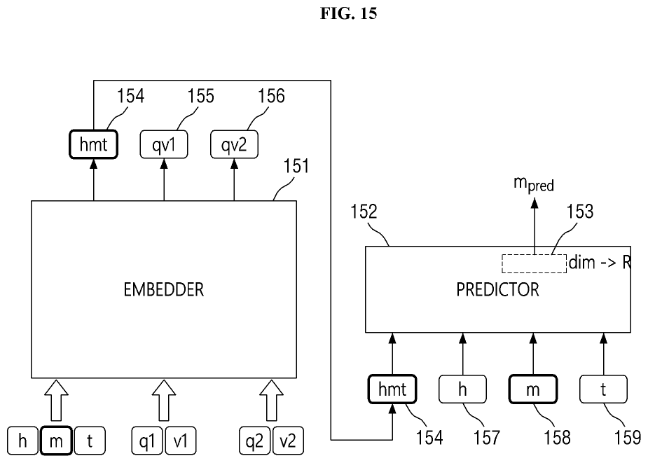

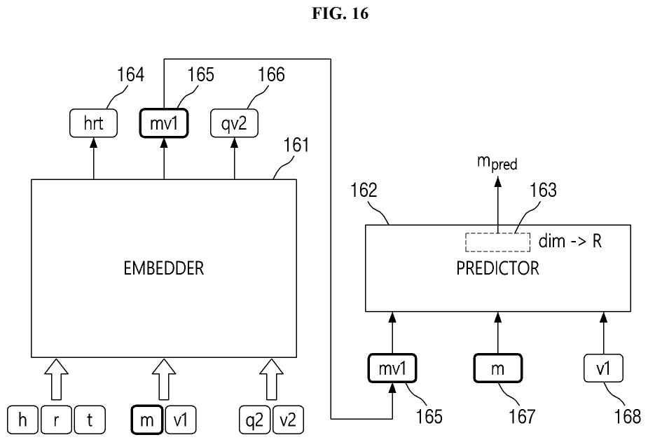

Hereinafter, a process of performing a relation (i.e., discrete relation) prediction task according to some example embodiments of the disclosure will be described with reference to FIGS. 15 and 16.

First, a process of predicting a relation of a basic knowledge instance will be described with reference to FIG. 15.

As illustrated in FIG. 15, the embedding system 10 may generate instance embeddings 154 to 156 for a basic knowledge instance and qualifier instances through an embedder 151. In one embodiment, the embedding system 10 may input an instance embedding 154 corresponding to the basic knowledge instance (i.e., the mask instance) among the instance embeddings 154 to 156 to a predictor 152. In this case, element embeddings 157 to 159 of the corresponding knowledge instance may also be input to the predictor 152.

Next, the embedding system 10 may calculate a probability distribution for predefined relations (e.g., R relations) through a prediction layer 153. As described above, the prediction layer 153 may be a classification layer and may calculate the predicted probability distribution based on the embedding corresponding to the mask element.

Next, a process of predicting a relation of a qualifier instance will be described with reference to FIG. 16.

As illustrated in FIG. 16, the embedding system 10 may generate instance embeddings 164 to 166 for a basic knowledge instance and qualifier instances through an embedder 161. In one embodiment, the embedding system 10 may input an instance embedding 165 corresponding to the qualifier instance (i.e., the mask instance) among the instance embeddings 164 to 166 to a predictor 162. In this case, element embeddings 167 and 168 of the corresponding knowledge instance may also be input to the predictor 162.

Next, the embedding system 10 may calculate a probability distribution for predefined relations (e.g., R relations) through a prediction layer 163. As described above, the prediction layer 163 may calculate the predicted probability distribution based on the embedding corresponding to the mask element.

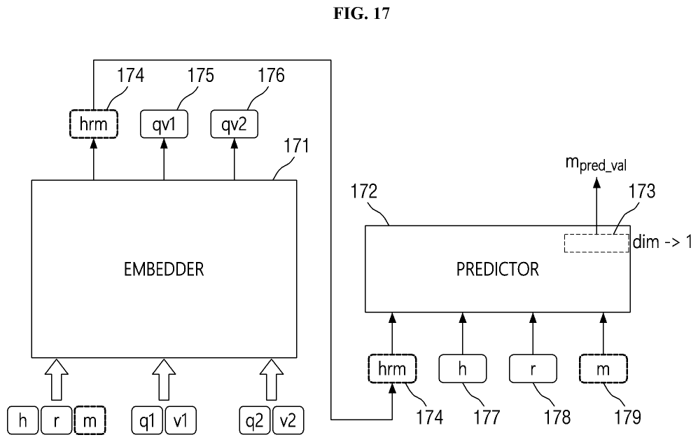

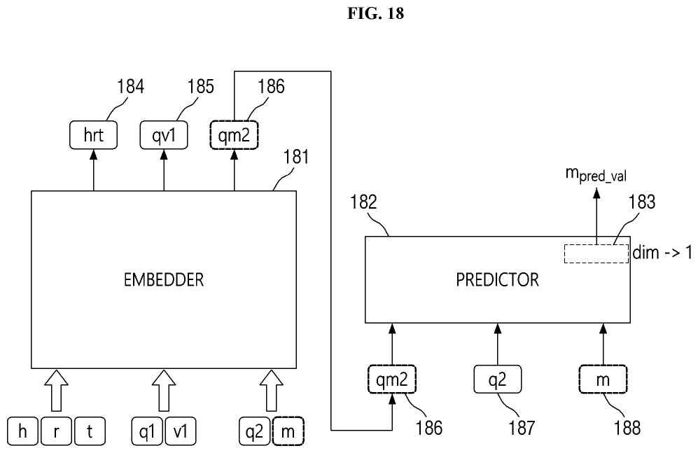

Hereinafter, a process of performing a numeric entity prediction task according to some example embodiments of the disclosure will be described with reference to FIGS. 17 and 18.

First, a process of predicting a numeric entity of a basic knowledge instance will be described with reference to FIG. 17.

As illustrated in FIG. 17, the embedding system 10 may generate instance embeddings 174 to 176 for a basic knowledge instance and qualifier instances through an embedder 171. In one embodiment, the embedding system 10 may input an instance embedding 174 corresponding to the basic knowledge instance (i.e., the mask instance) among the instance embeddings 174 to 176 to a predictor 172. In this case, element embeddings 177 to 179 of the corresponding knowledge instance may also be input to the predictor 172.

Next, the embedding system 10 may predict the numeric value (see m_{pred_val}) of the mask element through a prediction layer 173. Here, the prediction layer 173 may be a regression layer that outputs the predicted numeric value. For example, when the mask element has one numeric value, the prediction layer 173 may be a regression layer configured to output one numeric value. Similar to the described above, the prediction layer 173 may predict the numeric value based on the embedding corresponding to the mask element.

When the predicted numeric value is output, the embedding system 10 may update the weight parameters of the embedder and the predictor described above based on a difference (e.g., a mean square error) between the predicted numeric value and the correct answer about the numeric value.

When the value of a missing (mask) element of an incomplete knowledge instance (e.g., a basic knowledge instance or a qualifier instance) is predicted, the embedding system 10 may generate a complete knowledge instance by reflecting (or based on) the predicted numeric value.

Next, a process of predicting a numeric entity of a qualifier instance will be described with reference to FIG. 18. FIG. 18 illustrates a case of predicting a numeric entity of a second qualifier instance (i.e., a case where the mask instance is the second qualifier instance) as an example (see m).

As illustrated in FIG. 18, the embedding system 10 may generate instance embeddings 184 to 186 for a basic knowledge instance and qualifier instances through an embedder 181. In one embodiment, the embedding system 10 may input an instance embedding 186 corresponding to the qualifier instance (i.e., the mask instance) among the instance embeddings 184 to 186 to a predictor 182. In this case, element embeddings 187 and 188 of the corresponding knowledge instance may also be input to the predictor 182.

Next, the embedding system 10 may predict the numeric value (see m_{pred_val}) of the mask element through a prediction layer 183.

The detailed structures of the deep learning models and the processes of performing the prediction tasks according to some example embodiments of the disclosure have been described in detail with reference to FIGS. 10 to 18. As described above, the deep learning model may be trained through various tasks of predicting discrete entities, relations, numeric entities, and the like. Accordingly, the deep learning model may perform embedding while accurately reflecting even the numeric value of the knowledge graph.

Hereinafter, example embodiments of a parameter sharing structure of a deep learning model will be described with reference to FIG. 19.

As described above, the embedding system 10 may train the deep learning model through a plurality of prediction tasks (e.g., six prediction tasks illustrated in FIGS. 4 to 6). In this case, the predictors of the deep learning model may be configured to share at least some weight parameters with each other or may be configured independently of each other. Hereinafter, a description will be provided on the assumption that two prediction tasks are used for training of the deep learning model.

In some example embodiments, as illustrated in FIG. 19, the deep learning model may be configured to include an embedder 191 that is common and a first predictor 192 and a second predictor 195 sharing at least some weight parameters with each other. Here, the first predictor 192 may perform a first prediction task based on an embedding output from the embedder 191, and the second predictor 195 may perform a second prediction task based on an embedding output from the embedder 191. In the present example embodiment, a weight parameter sharing structure may be variously designed. For example, a context reflector 194 of the first predictor 192 may be configured to share all weight parameters with a context reflector 197 of the second predictor 195 or may be configured to share only some weight parameters with the context reflector 197 of the second predictor 195. When the first prediction task and the second prediction task predict the same type (e.g., discrete entity, relation, or numeric entity) of mask elements, the prediction layer 193 of the first predictor 192 and the prediction layer 196 of the second predictor 195 may also be configured to share at least some weight parameters with each other.

For reference, that a first module and a second module share all weight parameters with each other may mean that the first module and the second module are implemented as one module. For example, that the first predictor 192 and the second predictor 195 share all weight parameters with each other may mean that the first predictor 192 and the second predictor 195 are implemented as one module, and that the context reflector 194 of the first predictor 192 and the context reflector 197 of the second predictor 195 share all weight parameters with each other may mean that two predictors 192 and 195 share one context reflector with each other.

In some other example embodiments, the deep learning model may be configured to include an embedder (e.g., 191) that is common and a first predictor (e.g., 192) and a second predictor (e.g., 195) that are independent of each other.

In some other example embodiments, the deep learning model may be designed based on various combinations of the above-described example embodiments. For example, when all of the six prediction tasks illustrated in FIGS. 4 to 6 are used for training of the deep learning model, six predictors may be configured to share one context reflector with each other or predictors predicting the discrete entities may be configured to share one context reflector with each other and predictors predicting the numeric entities may be configured to share another context reflector with each other.

Example embodiments of the weight parameter sharing structure have been described with reference to FIG. 19.

The method for embedding a knowledge graph according to example embodiments have been described in detail with reference to FIGS. 7 to 19. According to some example embodiments of the disclosure, a deep learning model may be trained through various tasks of predicting discrete entities, relations, numeric entities, and the like. Accordingly, the deep learning model may perform embedding while accurately reflecting even a numeric value of a knowledge graph.

In one embodiment, the deep learning model may be trained through tasks for predicting entities or relations of a qualifier instance. Accordingly, the deep learning model may perform embedding while accurately reflecting even when a qualifier is added to the knowledge graph.

In one embodiment, the deep learning model may be configured to include an embedder outputting instance-based embeddings (i.e., instance embeddings) and a predictor predicting a mask element or a masked element. In one embodiment, the predictor is configured to predict the mask element based on the instance embedding associated with the mask element, and thus, embedding training for the knowledge graph may be performed accurately.

In one embodiment, the embedder may be configured and trained to generate instance embeddings by comprehensively considering (analyzing) element-based embeddings (i.e., element embeddings) for a basic knowledge instance and an associated qualifier instance. Accordingly, the embedder may perform embedding while accurately reflecting even an association between the basic knowledge instance and the qualifier instance constituting the knowledge graph.

In one embodiment, type information for distinguishing the instance embeddings from each other may be explicitly provided to the embedder. Accordingly, the embedder may perform embedding in consideration of types of input instance embeddings (i.e., types of the corresponding knowledge instances). As a result, embedding performance may be further improved.

In one embodiment, type information for distinguishing input embeddings from each other may be explicitly provided to the predictor. Accordingly, prediction may be performed in consideration of types of the embeddings (i.e., types of the corresponding knowledge instances or elements) input to the predictor.

In one embodiment, the predictor may generate a plurality of embeddings by comprehensively considering (analyzing) an instance embedding associated with the mask element and element embeddings, and perform prediction based on an embedding corresponding to the mask element among the generated embeddings. Accordingly, a prediction task for the mask element may be accurately performed.

In one embodiment, by predicting the missing (mask) element of an incomplete knowledge instance through the trained deep learning model, a complete knowledge instance may be easily generated from the incomplete knowledge instance. In one embodiment, by inserting complete knowledge instances into a given knowledge graph, the knowledge graph may be rapidly augmented.

The effects according to the technical spirit of the disclosure are not limited to the aforementioned effects, and various other effects may be obviously understood by one of ordinary skill in the art to which the disclosure pertains by referencing the detailed description of the disclosure given below.

Hereinafter, an illustrative computing device 200 capable of implementing the embedding system 10 according to some example embodiments of the disclosure will be described with reference to FIG. 20.

FIG. 20 is an illustrative hardware configuration diagram illustrating a computing device 200.

As illustrated in FIG. 20, the computing device 200 may include one or more processors 201, a bus 203, a communication interface 204, a memory 202 loading a computer program executed by the processor 201, and a storage 205 storing the computer program 206. However, only components related to an example embodiment of the disclosure are illustrated in FIG. 20. Additionally, one of ordinary skill in the art to which the disclosure pertains may know that the computing device 200 may further include other general-purpose components in addition to the components illustrated in FIG. 20. That is, the computing device 200 may further include various components in addition to the components illustrated in FIG. 20. In some cases, the computing device 200 may be configured in a form in which some of the components illustrated in FIG. 20 are omitted. Hereinafter, respective components of the computing device 200 will be described.

The processor 201 may control overall operations of the respective components of the computing device 200. The processor 201 may be configured to include at least one of a central processing unit (CPU), a microprocessor unit (MPU), a micro controller unit (MCU), a graphic processing unit (GPU), a neural processing unit (NPU), or any type of processor well known in the art to which the disclosure pertains. In one embodiment, the processor 201 may perform an arithmetic operation on at least one application or program for executing operations/methods according to example embodiments of the disclosure. The computing device 200 may include one or more processors.

Next, the memory 202 may store various data, commands, and/or information. The memory 202 may load the computer program 206 from the storage 205 in order to execute the operations/methods according to example embodiments of the disclosure. The memory 202 may be implemented as a volatile memory such as a random access memory (RAM), but the technical scope of the disclosure is not limited thereto.

Next, the bus 203 may provide a communication function between the components of the computing device 200. The bus 203 may be implemented as various types of buses such as an address bus, a data bus, and a control bus.

Next, the communication interface 204 may support wired/wireless Internet communication of the computing device 200. In one embodiment, the communication interface 204 may support various communication manners other than the Internet communication. To this end, the communication interface 204 may be configured to include a communication module well known in the art to which the disclosure pertains.

Next, the storage 205 may non-temporarily store one or more computer programs 206. The storage 205 may be configured to include a non-volatile memory such as a read only memory (ROM), an erasable programmable ROM (EPROM), an electrically erasable programmable ROM (EEPROM), or a flash memory, a hard disk, a removable disk, or any type of computer-readable recording medium well known in the art to which the disclosure pertains.

Next, the computer program 206 may include one or more instructions for causing the processor 201 to perform operations/methods according to various example embodiments of the disclosure when they are loaded into the memory 202. That is, the processor 201 may perform the operations/methods according to various example embodiments of the disclosure by executing the one or more loaded instructions.

For example, the computer program 206 may include instructions for performing an operation of obtaining a basic knowledge instance and a qualifier instance associated with the basic knowledge instance, an operation of generating a first instance embedding and a second instance embedding respectively corresponding to the basic knowledge instance and the qualifier instance through an embedder, and an operation of predicting a mask element by inputting, to the predictor, an instance embedding associated with the mask element. The instance embedding may correspond to the first instance embedding or the second instance embedding. In such a case, the embedding system 10 according to some example embodiments of the disclosure may be implemented through the computing device 200.

In some example embodiments, the computing device 200 illustrated in FIG. 20 may also refer to a virtual machine implemented based on cloud technology. For example, the computing device 200 may be a virtual machine operating on one or more physical servers included in a server farm. In this case, at least some of the processor 201, the memory 202, and the storage 205 illustrated in FIG. 20 may be virtual hardware, and the communication interface 204 may also be implemented as a virtualized networking element such as a virtual switch.

The illustrative computing device 200 capable of implementing the embedding system 10 according to some example embodiments of the disclosure has been described with reference to FIG. 20.

Various example embodiments of the disclosure and effects according to these example embodiments have been mentioned with reference to FIGS. 1 to 20. The effects according to the technical spirit of the disclosure are not limited to the aforementioned effects, and various other effects may be obviously understood by one of ordinary skill in the art to which the disclosure pertains by referencing the detailed description of the disclosure given below.

The technical features of the disclosure described herein may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the disclosure. Therefore, the disclosed example embodiments of the disclosure are used in a generic and descriptive sense only and not for purposes of limitation.

What is claimed is:

1. A method for embedding a knowledge graph, the method being performed by at least one processor and comprising:
obtaining a basic knowledge instance and a qualifier instance associated with the basic knowledge instance, wherein at least one of the basic knowledge instance or the qualifier instance comprises a mask element;
generating, through an embedder, a first instance embedding corresponding to the basic knowledge instance and a second instance embedding corresponding to the qualifier instance; and
performing a prediction of the mask element by inputting, to a predictor, an instance embedding associated with the mask element, wherein the instance embedding corresponds to the first instance embedding or the second instance embedding.

2. The method of claim 1, further comprising updating the embedder and the predictor, based on a difference between a result of the prediction and a correct answer about the mask element.

3. The method of claim 1, wherein the embedder comprises a context encoder configured to:
perform an analysis of an association between a first embedding of the basic knowledge instance and a second embedding of the qualifier instance; and
generate the first instance embedding and the second instance embedding based on a result of the analysis of the association between the first embedding of the basic knowledge instance and the second embedding of the qualifier instance.

4. The method of claim 3, wherein the context encoder is implemented based on a self-attention module.

5. The method of claim 3, wherein the generating of the first instance embedding and the second instance embedding comprises:
reflecting type information for distinguishing the basic knowledge instance and the qualifier instance from each other in the first embedding and the second embedding; and
analyzing the association between the first embedding and the second embedding in which the type information is reflected through the context encoder.

6. The method of claim 3, wherein the embedder further comprises:
a basic aggregator configured to aggregate first element embeddings of the basic knowledge instance to generate the first embedding; and
an auxiliary aggregator configured to aggregate second element embeddings of the qualifier instance to generate the second embedding.

7. The method of claim 1, wherein the qualifier instance is a first qualifier instance, and
wherein the generating of the first instance embedding and the second instance embedding comprises:
obtaining a second qualifier instance associated with the basic knowledge instance;
performing, through the embedder, an analysis of an association among embeddings of the basic knowledge instance, the first qualifier instance, and the second qualifier instance; and
generating the first instance embedding and the second instance embedding based on a result of the analysis of the association.

8. The method of claim 1, wherein the predicting of the mask element comprises inputting, to the predictor, element embeddings of a knowledge instance comprising the mask element.

9. The method of claim 8, wherein the inputting of the element embeddings of the knowledge instance comprises:
reflecting, in the element embeddings, information for distinguishing types of elements from each other, and
inputting, to the predictor, the element embeddings in which the information is reflected.

10. The method of claim 9, wherein type information of the knowledge instance corresponding to the instance embedding is reflected in the instance embedding associated with the mask element, and
wherein the instance embedding in which the type information is reflected is input to the predictor.

11. The method of claim 8, wherein the predictor comprises a context reflector and a prediction layer, and
wherein the predicting of the mask element comprises:
generating a plurality of embeddings by reflecting, through the context reflector, the instance embedding associated with the mask element in the element embeddings; and
predicting the mask element by inputting, to the prediction layer, an embedding corresponding to the mask element among the plurality of embeddings.

12. The method of claim 11, wherein the context reflector is implemented based on a self-attention module.

13. The method of claim 1 wherein the mask element is a discrete entity, and
wherein the predictor comprises a classification layer configured to output a predicted probability distribution for predefined entities.

14. The method of claim 1, wherein the mask element is a relation, and
wherein the predictor comprises a classification layer configured to output a predicted probability distribution for predefined relations.

15. The method of claim 1 wherein the mask element is a numeric entity, and
wherein the predictor comprises a regression layer configured to output a predicted numeric value.

16. The method of claim 1, wherein the predictor comprises a first predictor associated with a first prediction task and a second predictor associated with a second prediction task, and
wherein, based on at least one of a type of the mask element, a format of a value of the mask element, and a type of a knowledge instance comprising the mask element, the first prediction task and the second prediction task are distinguished from each other.

17. The method of claim 16, wherein the first predictor and the second predictor are configured to share at least one weight parameter with each other.

18. The method of claim 1, further comprising:
generating a complete knowledge instance based on a result of the prediction in a knowledge instance comprising the mask element; and
inserting the generated complete knowledge instance into the knowledge graph.

19. A method for embedding a knowledge graph, the method being performed by at least one processor and comprising:
obtaining a knowledge instance including a mask element, the mask element being a numeric entity;
generating, through an embedder, an instance embedding of the knowledge instance; and
predicting a value of the mask element by inputting, to a predictor comprising a regression layer, the instance embedding.

20. A system for embedding a knowledge graph, the system comprising:
one or more processors; and
a memory configured to store one or more instructions,
wherein the one or more processors are configured to, by executing the stored one or more instructions, perform:
obtaining a basic knowledge instance and a qualifier instance associated with the basic knowledge instance, wherein at least one of the basic knowledge instance or the qualifier instance comprises a mask element,
generating, through an embedder, a first instance embedding corresponding to the basic knowledge instance and a second instance embedding corresponding to the qualifier instance, and
predicting the mask element by inputting, to a predictor, an instance embedding associated with the mask element, wherein the instance embedding corresponds to the first instance embedding or the second instance embedding.
